(19) United States
(12) Patent Application Publication
(10) Pub. No.: US 2008/0231605 A1
(43) Pub. Date: Sep. 25, 2008

(54) Compound touch panel

(76) Inventor: Kai-Ti Yang, Taipei (TW)

Correspondence Address: KAI-TI YANG, 235 Chung-Ho, Box 8-24, Taipei, TW

(21) Appl. No.: 11/726,046

(22) Filed: Mar. 21, 2007

(51) Int. Cl. G06F 3/041

(52) U.S. Cl. 345/173

(57) ABSTRACT

A compound touch panel comprises a capacitive touch panel unit; a resistive touch panel unit and a signal processing unit; the capacitive touch panel unit is overlapped with the resistive touch panel unit; sensing signals from the capacitive touch panel unit and resistive touch panel unit being transferred to the signal processing unit; the signal processing unit having at least one signal determining loop for determining the sensing signals being from the capacitive touch panel unit or the resistive touch panel unit so as to select a predetermined signal processing mode. Or the signal processing unit having a manual operated signal switch for selecting a signal processing mode based on whether sensing signals are from the capacitive touch panel unit or resistive touch panel unit. When the capacitive touch panel unit is selected from receiving signals, the conductive films of the resistive touch panel unit are jumped for grounding.

### FIELD OF THE INVENTION

The present invention relates to touch panels, and particularly to a compound touch panel which combines a resistive touch panel unit with a capacitive touch panel unit so that the compound touch panel has the advantages of the two kinds of touch panels, which the defects of the two kinds of touch panels are removed.

### BACKGROUND OF THE INVENTION

The touch panels are widely used in various electronic devices. In general, the touch panels can be divided into three kinds, one is capacitive touch panels, another is resistive touch panels and the other is electromagnetic touch panels. Every kind of panel has its advantages and thus they are used in different fields, for example the resistive touch panels are used in personal digital assistants (PDAs), electronic dictionaries, handsets, MP3s, digital players, or global positioning systems (GPSs), or other small size electronic devices. The capacitive touch panels are mainly used in the notebooks, or virtual touch keyboards, etc.

Moreover, the capacitive touch panel includes an X axis sensing layer (X trace) and a Y axis sensing layer (Y trace). The X axis sensing layer and Y axis sensing layer are isolatedly installed in a touch plate. The X axis sensing layer and Y axis sensing layer are grounded individually and are connected to a control circuit. In operation, when a finger touches upon a surface of the touch panel, a capacitive effect will generate. A control circuit will assure the touch position of the finger or conductor by the variation of the capacitor. The capacitive touch panel can be inputted by fingers so that it is convenient in operation. Moreover, in data input operation, no pressure is applied and thus no over larger stress is applied to the touch panel and thus the panel will not deform. Further, the capacitive touch panel is made of less components with a simple structure. The yield ratio is high and it is suitable for mass production. Furthermore, the touch panel can sense the input operations in multiple points. That is, it is suitable for multiplex operation and is also suitable for high level operation, such as electronic games, which makes the operation objects being more active and vivid. However this kind of capacitive touch panel still has many defects necessary to be improved. For example, the capacitive touch panel is easily interfered by electromagnetic waves so as to induce noises and thus the input signals will be adjudged incorrectly, even the fault operation is induced. Besides, the sensitivity of the finger input is low, particular to the input of texture, such as Chinese characters. Although dedicated pens are designed for improving above mentioned defects, it is still not suitable for being used in a small area touch panel with higher precision. Furthermore, the use of dedicated pen is also inconvenient in many fields, for example the pen is not carried out or the pen is lost.

The resistive touch panel has two sheets of transparent conductive films which are separated with a gap therebetween. The upper conductive film is installed on a surface of a transparent thin film and the lower conductive film is installed on a surface of a hard transparent glass substrate. The two conductive films are tightly sealed within a plate like structure. The upper conductive film and lower conductive film are transparent and thus is suitable to be installed upon a display screen so that the user can input upon the touch panel which is directly corresponding to a position of the screen. The resistive touch panel can be inputted by a pen tip precisely and is suitable for small area input with higher precision, such as input of textures with complex strokes. However the operation of the resistive touch panel is performed by pressure upon the panel, and thus for a long time, the panel will deform or even is destroyed by the repeatedly operation. As a result, the lifetime of the resistive touch panel is finite. Thereby if it is inputted by fingers or other tools with greater input ends, the precision is reduced greatly.

Therefore, from above description, it is known that the capacitive touch panel and resistive touch panel unit have their intrinsic defects which are necessary to be improved.

### SUMMARY OF THE INVENTION

Accordingly, the primary object of the present invention is to provide a compound touch panel which combines a resistive touch panel unit with a capacitive touch panel unit so that the compound touch panel has the advantages of the two kinds of touch panels, in which the defects of the two kinds of touch panels are removed.

To achieve above objects, the present invention provides a compound touch panel comprising: a first touch panel unit and a second touch panel unit. The first touch panel unit has a panel made of flexible highly transparent insulated thin film; a first axis sensing layer being a transparent film with good conductivity; the first axis sensing layer having a plurality of first axis sensing traces; ends of each trace having respective joints; an insulation layer being a transparent insulated film layer; a second axis sensing layer being a transparent film with good conductivity; the second axis sensing layer having a plurality of second axis sensing traces; ends of each trace having respective joints; a bottom plate being a flexible highly transparent insulated film; and a first signal output wire bank having a plurality of conductive paths. The panel, first axis sensing layer, second axis sensing layer, bottom plate and first signal output wire bank are glued together sequentially as a transparent plate like body; the first axis sensing traces and second axis sensing traces are arranged along different directions so as to form as a matrix; the joints of the first axis sensing layer and second axis sensing layer are connected to silver conductive wires at edges of the bottom plates and are connected to the first signal output wire bank so that signals from the first axis sensing layer and second axis sensing layer are transferred to a signal processing unit through the first signal output wire bank.

The second touch panel unit has a top plate being a flexible highly transparent insulated film; an upper conductive film installed with electronic nodes and being a transparent film with good conductivity; a lower conductive film installed with electronic nodes and being a transparent film with good conductivity; a substrate being a transparent insulated plate; and a second signal output wire bank having a plurality of conductive paths thereon; and wherein the upper conductive film is installed on a bottom surface of the top plate and the lower conductive film is installed on an upper surface of the substrate; a plurality of spacing balls are installed between the upper conductive film and lower conductive film so as to form a gap therebetween; edges of the upper conductive film and lower conductive film are formed with insulated gluing layers for gluing the two layers as a transparent plate; signals from the upper conductive film and lower conductive film are collected by the silver conductive wires at the edges of the upper conductive film and lower conductive film and then are transferred to the signal processing unit through the second signal output wire bank for further processing.

The first touch panel unit is a capacitive touch panel unit and the second touch panel unit is a resistive touch panel unit; the first touch panel unit is overlapped with the second touch panel unit as a plate structure.

The first axis sensing layer and second axis sensing layer are made of material of good conductivity, such as indium tin oxide.

The second touch panel unit is installed below the first touch panel unit.

The bottom plate of the first touch panel unit is also used as the top plate of the second touch panel unit.

A surface of the panel is coated with a layer of hard coat so as to increase the anti-crack and anti-dust ability on the surface.

Moreover, the present invention provides a compound touch panel which comprises a capacitive touch panel unit; a resistive touch panel unit and a signal processing unit; the capacitive touch panel unit is overlapped with the resistive touch panel unit; sensing signals from the capacitive touch panel unit and resistive touch panel unit are transferred to the signal processing unit; the signal processing unit having at least one signal determining loop for determining the sensing signals being from the capacitive touch panel unit or the resistive touch panel unit so as to select a predetermined signal processing mode for further processing. When the signal processing mode is selected to receive the sensing signals from the capacitive touch panel unit, the upper conductive film and lower conductive film of the resistive touch panel unit are jumped for grounding of the capacitive touch panel unit so as to avoid electromagnetic interference.

Moreover, the present invention provides a compound touch panel which comprises a capacitive touch panel unit; a resistive touch panel unit and a signal processing unit; the capacitive touch panel unit is overlapped with the resistive touch panel unit; sensing signals from the capacitive touch panel unit and resistive touch panel unit are transferred to the signal processing unit; the signal processing unit having at least one manual operated signal switch for selecting a signal processing mode based on whether sensing signals are from the capacitive touch panel unit or resistive touch panel unit. When the signal processing mode is selected to receive the sensing signals from the capacitive touch panel unit, the upper conductive film and lower conductive film of the resistive touch panel unit are jumped for grounding of the capacitive touch panel unit so as to avoid electromagnetic interference.

The various objects and advantages of the present invention will be more readily understood from the following detailed description when read in conjunction with the appended drawing.

### BRIEF DESCRIPTION OF THE DRAWINGS

FIG. 1 is a structural cross sectional view of the present invention.

FIG. 2 is a schematic view showing the sensing layers of the capacitive touch panel unit of the present invention.

FIG. 3 is an exploded view of the resistive touch panel unit of the present invention.

FIG. 4 is a lateral cross sectional view of another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

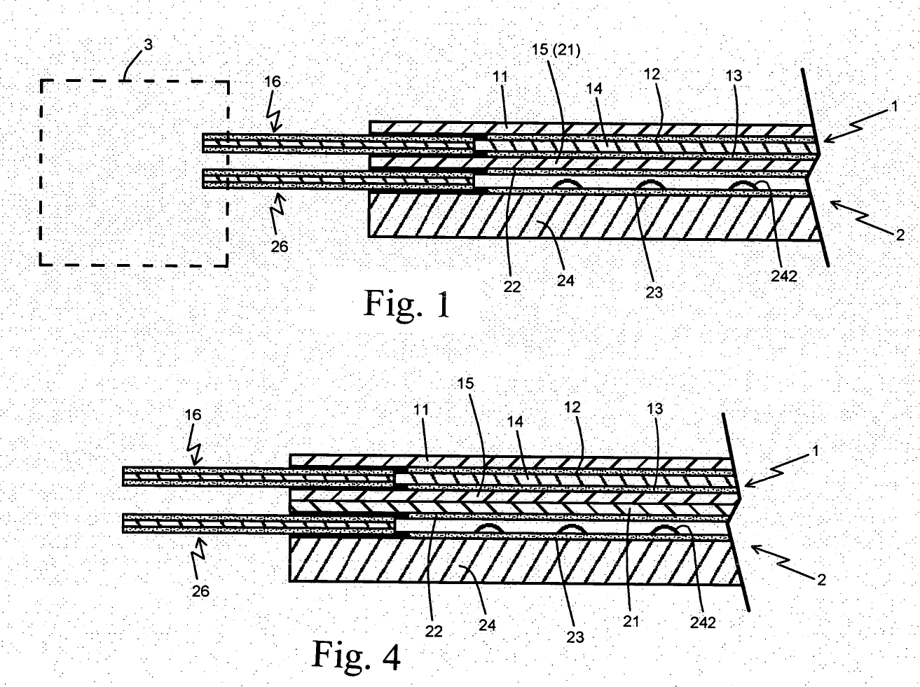

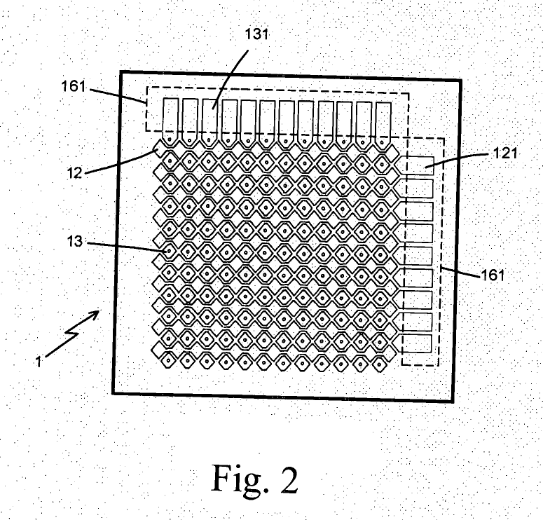

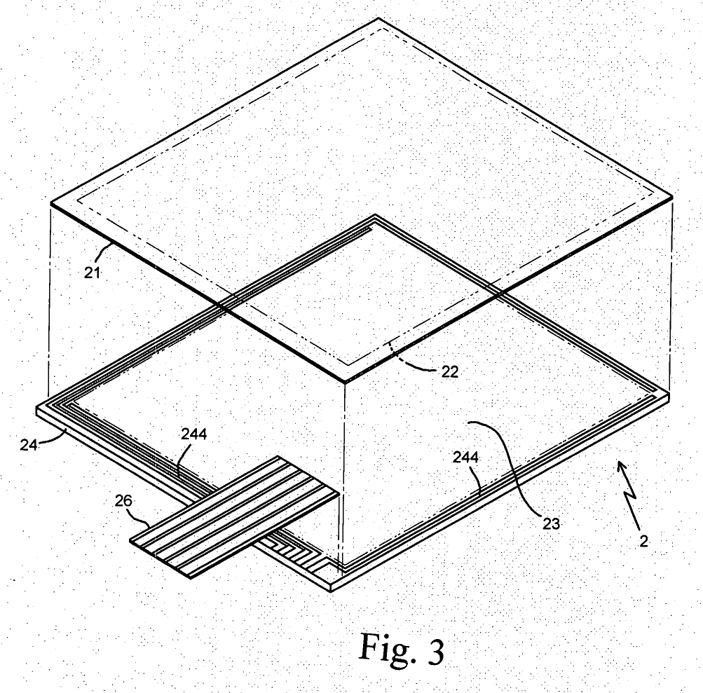

Referring to FIGS. 1 to 3, the preferred embodiment of the present invention is illustrated. The present invention has the following elements. A capacitive touch panel unit 1 has a panel 11, an X axis sensing layer 12, a Y axis sensing layer 13, an insulation layer 14 installed between the X axis sensing layer 12 and Y axis sensing layer 13, a bottom plate 15 and a first signal output wire bank 16. The panel 11 is a high flexible light transmission insulating film, such as polyester (PET) thin film material. A surface of the panel 11 is coated with a layer of hard coat, such as a coat of high hardness ultraviolet hardened paint so as to increase the anti-crack and anti-dust abilities on the surface. The material of X axis sensing layer 12 and Y axis sensing layer 13 may be selected from a transparent film with good conductivity, such as material of indium tin oxide (ITO) film. The material of the insulation layer 14 connected the X axis sensing layer 12 and Y axis sensing layer 13 is selected from transparent insulating material, such as oily ink or high transparency polyester films. The material of the first signal output wire bank 16 is selected from flexible printed circuit (FPC) boards. A plurality of conductive wires are arranged on the first signal output wire bank 16. All above mentioned layers can be glued together as a transparent body. The X axis sensing layer 12 has a plurality of joints 121 and the Y axis sensing layer 13 has a plurality of joints 131. The joints 121 and joints 131 are conductively connected through the silver conductive circuit 161 at the edges of the X axis sensing layer 12 and Y axis sensing layer 13. The signals is transferred to the first signal output wire bank 16 and then to a signal processing unit 3.

A resistive touch panel unit 2 has a top plate 21, an upper conductive film 22, a substrate 24, and a second signal output wire bank 26. In this embodiment, the material of the top plate 21 is the same as that of the bottom plate 15 of the capacitive touch panel unit 1. However some other material can be used, in that the material of the top plate 21 is different from that of the resistive touch panel unit 2 (referring to FIG. 4). When the capacitive touch panel unit 1 is overlapped with the resistive touch panel unit 2 as a plate body. The top plate 21 is glued with the bottom plate 15. The substrate 24 is made of hard plate, such as transparent glass plates, acryl plates, or polyester plates. The material of the second signal output wire bank 26 is selected from flexible printed circuit board and a plurality of conductive wires are arranged on the second signal output wire bank 26. The upper conductive film 22 is an indium tin oxide thin film with a plurality of electric nodes thereon and is installed on an upper surface of the substrate 24. Besides, a plurality of spacing balls 242 are arranged between the upper conductive film 22 and the lower conductive film 23 so as to have a gap therebetween. The peripheries of the upper conductive film 22 and lower conductive film 23 are arranged with insulated gluing layers for combining the two as a transparent plate body. Moreover, the signals of two conductive films are transferred to the resistive touch panel unit 2 through the silver conductive circuits 244 on the edges of the two conductive films. Since the capacitive touch panel unit 1 is very thin, when it is installed on the resistive touch panel unit 2, it will not reduce the sensitivity of the resistive touch panel unit 2, while it can buffer the impact from the stress of the indium tin oxide of the upper conductive film 22 so as to avoid the destroy on the edges of two units and prolong the lifetime of the structure.

The signal processing unit 3 has a signal determined loop for determining the sensing signals from the capacitive touch panel unit 1 and/or the resistive touch panel unit 2 so as to select a proper signal processing mode automatically for further signal processing. For example, when the user inputs through the compound touch panel of the present invention, the touch from the finger will generate capacitive sensing signals on the X axis sensing layer 12 and Y axis sensing layer 13 of the capacitive touch panel unit 1. Because no stress from the finger is applied to the panel, the resistive touch panel unit 2 generates no signal. As a result, when the signals from the capacitive touch panel unit 1 passes through the first signal output wire bank 16 to the signal processing unit 3, the signal determining loop of the signal processing unit 3 determines to use the capacitive sensing signal mode to process the signals. In this mode, the signal processing unit 3 only accepts the sensing signals from the capacitive touch panel unit 1 and the signals from the resistive touch panel unit 2 will not isolate. Further, in the resistive sensing signal processing mode, the signal processing unit 3 will jump through the upper conductive film 22 and lower conductive film 23 as the grounding layer of the X axis sensing layer 12 and Y axis sensing layer 13 of the capacitive touch panel unit 1 so as to prevent electrostatic interference or electromagnetic wave interference. Especially, when the compound touch panel of the present invention is installed on a display screen, the present invention can avoid the repeated actions of the radiation (light or electromagnetic radiations) so as not to generate residue electrostatic or electromagnetic wave interferences. Thus the capacitive touch panel unit 1 can operate normally.

Furthermore, when the user uses a pen tip to touch the compound touch panel of the present invention, the tip will press upon a working area of the panel 11, since the capacitive touch panel unit 1 at the upper side is very thin and is made of flexible material. The pressure from the tip will transfer through the capacitive touch panel unit 1 to the resistive touch panel unit 2 easily. Then the upper conductive film 22 and lower conductive film 23 will be conductive so as to generate sensing signals. Moreover, since the tip do not trigger a capacitive sensing signal as it slides or touch upon the panel, the capacitive touch panel unit 1 generates no signal. As a result, when the sensing signals of the resistive touch panel unit 2 passes through the second signal output wire bank 26 to the signal processing unit 3, the signal determining loop of the signal processing unit 3 will determine to the select the resistive sensing signal processing mode. Under this mode, the signal processing unit 3 only accepts the sensing signals from the resistive touch panel unit 2 and isolates the sensing signals from the capacitive touch panel unit 1.

Furthermore, for example, when the one input operation generates two sensing signals, for example, a pen form conductor is used as an input device, the conductor will cause the capacitive touch panel unit 1 to generate sensing signals and the pressure from the tip of the pen will cause the resistive touch panel unit 2 to generate sensing signals. As a result, these two sensing signals are transferred to the signal processing unit 3 simultaneously. The signal determining loop of the signal processing unit 3 will make the following determination. In a continuous touch operation, it selects the sensing signals which are inputted continuously. That is, the discontinuous sensing signals or the sensing signals with changed inputted modes will not be selected. In a discontinuous sensing operation or a new sensing operation, a default mode for the sensing signal processing has the priority for being used, for example the capacitive sensing signal mode is selected to have the priority for operation. When one operation mode is selected, the operation is identical to those described above.

In some special demand, the signal determining loop of the signal processing unit 3 can be replaced by a manual operated signal switching so that the user can select a desired signal processing mode. When the capacitive sensing signal processing mode is selected, the signal processing unit 3 only accepts the sensing signals from the capacitive touch panel unit 1 and isolates the sensing signals from the resistive touch panel unit 2. When the switching is switched to accept the sensing signals from the resistive touch panel unit 2, the signal processing unit 3 only accepts the sensing signals from the resistive touch panel unit 2 and isolates the sensing signals from the capacitive touch panel unit 1.

In FIGS. 1 to 3, it is illustrated that the top plate 21 and the bottom plate 15 are identical.

FIG. 4 shows another embodiment of the present invention, wherein the top plate 21 and the bottom plate 15 are different, which also presents the same effect as the above embodiment.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A compound touch panel comprising:
a first touch panel unit having
a panel made of flexible highly transparent insulated thin film;
a first axis sensing layer being a transparent film with good conductivity; the first axis sensing layer having a plurality of first axis sensing traces; ends of each trace having respective joints;
an insulation layer being a transparent insulated film layer;
a second axis sensing layer being a transparent film with good conductivity; the second axis sensing layer having a plurality of second axis sensing traces; ends of each trace having respective joints;
a bottom plate being a flexible highly transparent insulated film; and
a first signal output wire bank having a plurality of conductive paths;
wherein the panel, the first axis sensing layer, the second axis sensing layer, the bottom plate and the first signal output wire bank are glued together sequentially as a transparent plate like body; the first axis sensing traces and second axis sensing traces are arranged along different directions so as to form as a matrix; the joints of the first axis sensing layer and second axis sensing layer are connected to silver conductive wires at edges of the bottom plates and are connected to the first signal output wire bank so that signals from the first axis sensing layer and second axis sensing layer are transferred to a signal processing unit through the first signal output wire bank;
a second touch panel unit having:
a top plate being a flexible highly transparent insulated film;
an upper conductive film installed with electronic nodes and being a transparent film with good conductivity;
a lower conductive film installed with electronic nodes and being a transparent film with good conductivity;
a substrate being a transparent insulated plate; and
a second signal output wire bank having a plurality of conductive paths thereon; and
wherein the upper conductive film is installed on a bottom surface of the top plate and the lower conductive film is installed on an upper surface of the substrate; a plurality of spacing balls are installed between the upper conductive film and the lower conductive film so as to form a gap therebetween; edges of the upper conductive film and lower conductive film are formed with insulated gluing layers for gluing the two layers as a transparent plate; signals from the upper conductive film and lower conductive film are collected by the silver conductive wires at the edges of the upper conductive film and lower conductive film and then are transferred to the signal processing unit through the second signal output wire bank for further processing; and
wherein the first touch panel unit is a capacitive touch panel unit and the second touch panel unit is a resistive touch panel unit; the first touch panel unit is overlapped with the second touch panel unit as a plate structure.

2. The compound touch panel as claimed in claim 1, wherein the second touch panel unit is installed below the first touch panel unit.

3. The compound touch panel as claimed in claim 1, wherein the bottom plate of the first touch panel unit is also used as the top plate of the second touch panel unit.

4. The compound touch panel as claimed in claim 1, wherein a surface of the panel is coated with a layer of hard coat so as to increase the anti-crack and anti-dust ability on the surface.

5. A compound touch panel comprising a capacitive touch panel unit; a resistive touch panel unit and a signal processing unit; the capacitive touch panel unit is overlapped with the resistive touch panel unit; sensing signals from the capacitive touch panel unit and resistive touch panel unit are transferred to the signal processing unit; the signal processing unit having at least one signal determining loop for determining the sensing signals being from the capacitive touch panel unit or the resistive touch panel unit so as to select a predetermined signal processing mode for further processing.

6. The compound touch panel as claimed in claim 5, wherein when the signal processing mode is selected to receive the sensing signals from the capacitive touch panel unit, the upper conductive film and lower conductive film of the resistive touch panel unit are jumped as grounding of the capacitive touch panel unit.

7. A compound touch panel comprising a capacitive touch panel unit; a resistive touch panel unit and a signal processing unit; the capacitive touch panel unit is overlapped with the resistive touch panel unit; sensing signals from the capacitive touch panel unit and resistive touch panel unit are transferred to the signal processing unit; the signal processing unit having at least one manual operated signal switch for selecting a signal processing mode based on whether sensing signals are from the capacitive touch panel unit or resistive touch panel unit.

8. The compound touch panel as claimed in claim 7, wherein when the signal processing mode is selected to receive the sensing signals from the capacitive touch panel unit, the upper conductive film and lower conductive film of the resistive touch panel unit are jumped as grounding of the capacitive touch panel unit.
